(19) United States
(12) Patent Application Publication
(10) Pub. No.: US 2018/0251639 A1
(43) Pub. Date: Sep. 6, 2018

(54) HEAT-DISSIPATING COATING COMPOSITION, HEAT-DISSIPATING MEMBER, ARTICLE

(71) Applicant: JNC CORPORATION, TOKYO (JP)

(72) Inventors: MASAKO HINATSU, ICHIHARA-SHI, CHIBA (JP); TAKESHI FUJIWARA, ICHIHARA-SHI, CHIBA (JP)

(73) Assignee: JNC CORPORATION, TOKYO (JP)

(21) Appl. No.: 15/756,986

(22) PCT Filed: Sep. 1, 2016
(86) PCT No.: PCT/JP2016/075694

§ 371 Date: Mar. 2, 2018

(30) Foreign Application Priority Data
Sep. 2, 2015 (JP) 2015-173357

(51) Int. Cl. C09D 5/00; C09K 5/14; C09D 151/08; C09D 7/61

(52) U.S. Cl. CPC C09D 5/00; C09K 5/14; C08K 3/34; C09D 7/61; C09D 151/085

(57) ABSTRACT

Provided is a heat-dissipating coating composition having capability of forming a coating film having a high heat-dissipating effect, and having capability of forming the coating film also excellent in heat resistance and UV resistance. The heat-dissipating coating composition of the present application contains a filler of an orthorhombic silicate mineral; and an acrylic resin and a curing agent. Either the acrylic resin or the curing agent is silicone-modified.

### TECHNICAL FIELD

The invention relates to a heat-dissipating coating composition, and in particular, to a heat-dissipating coating composition having capability of forming a heat-dissipating member having high heat resistance and high UV resistance.

### BACKGROUND ART

An orthorhombic silicate mineral is known as far infrared radiation ceramics, and has a function of decreasing temperature by efficiently converting heat energy into far infrared rays, and dissipating the far infrared rays to outside. Patent literature No. 1 discloses a heat-dissipating coating composition having capability of forming a coating film having a high heat-dissipating effect and transparency by combining such an orthorhombic silicate mineral with a resin (paragraphs: 0005 to 0007, Patent literature No. 1).

A use environment of the coating film having heat-dissipating properties is not limited to an indoor environment. For example, a large number of devices requiring heat radiation, such as a traffic signal and a power supply BOX for outdoor use, are used also outdoors. Thus, the coating film having heat-dissipating properties is required to be a material that can withstand outdoor use.

### CITATION LIST

### Patent Literature

Patent literature No. 1: JP 2013-100154 A

### SUMMARY OF INVENTION

### Technical Problem

Accordingly, an object of the invention is to provide a heat-dissipating coating composition having capability of forming a coating film having a high heat-dissipating effect, and also excellent heat resistance and UV resistance.

### Solution to Problem

The present inventers have diligently continued to conduct study in order to solve the above object. As a result, the present inventers have found that a coating film having a high heat-dissipating effect, and also excellent heat resistance and UV resistance can be formed when a silicone-modified acrylic resin is combined with a filler of an orthorhombic silicate mineral, and have completed the invention.

A heat-dissipating coating composition according to a first aspect of the invention contains a filler of an orthorhombic silicate mineral; and an acrylic resin and a curing agent, wherein either the acrylic resin or the curing agent is silicone-modified.

The “silicate mineral” may be any of a natural material and an artificial material, and contains an aluminosilicate mineral, and also a silicate compound other than a mineral. The “acrylic resin” before curing contains not only a polymer having a crosslinkable functional group, but also a monomer and an oligomer. “Silicone-modified” means that a material is modified with silicone, and provided with characteristics of the silicone.

If the composition is thus configured, a cured film (coating film) formed of the heat-dissipating coating composition of the invention of the present application contains the orthorhombic silicate mineral, and therefore heat-radiating properties are increased. Further, the resin may be formed into a silicone-modified acrylic resin by curing, and therefore the cured film formed of the heat-dissipating coating composition can have excellent heat resistance and UV resistance.

In a heat-dissipating coating composition according to a second aspect of the invention, the heat-dissipating coating composition according to the first embodiment of the invention, wherein the acrylic resin is a curable resin composed of a silicone-modified (meth)acrylic compound, and the curing agent is a curing agent containing an isocyanate group, or the acrylic resin is a curable resin composed of a (meth)acrylic compound, and the curing agent is a silicone-modified curing agent containing an isocyanate group. In addition, if one is silicone-modified, the other is not silicone-modified. The “(meth)acrylic compound” refers to an acrylic compound or a (meth)acrylic compound (=a methacrylic compound).

If the composition is thus configured, the acrylic compound has a high rate of a polymerization reaction, and therefore such a case is preferred. Further, the acrylic compound can be easily produced from alcohols corresponding thereto, and therefore a wide variety of acrylate monomers or acrylate oligomers are available, and a material can be selected according to the purpose to easily modify physical properties of the cured film, and therefore such a case is preferred.

The methacrylic compound has a lower rate of reaction than the acrylic compound has, but the methacrylic compound has low skin irritation, and therefore is preferred.

In a heat-dissipating coating composition according to a third aspect of the invention, the heat-dissipating coating composition according to the first aspect or the second aspect of the invention, wherein the orthorhombic silicate mineral is cordierite or mullite.

If the composition is thus configured, the fillers are lightweight, excellent in the heat-dissipating properties, chemically stable, high in affinity with the resin, and less harmful to a human body. Accordingly, the heat-dissipating coating composition of the invention has capability of forming the cured film utilizing the above features. The fillers are used as far infrared radiation ceramics, and can provide the cured film with characteristics of being particularly excellent in far infrared radiation.

In a heat-dissipating coating composition according to a fourth aspect of the invention, the heat-dissipating coating composition according to any one of the first to third aspects of the invention, further containing at least one kind of additional filler selected from the group of boron nitride, aluminum nitride, silica, alumina, zinc oxide, graphite and nanodiamond.

If the composition is thus configured, thermal conductivity of the cured film formed of the heat-dissipating coating composition can be improved by the additional filler. Further, the cured film can be colored to white using boron nitride, or black using graphite, and therefore design performance of a heat-dissipating member can be improved.

A heat-dissipating member according to a fifth aspect of the invention is a cured film to be arranged in a thermal conductive component having a thermal conductivity of 8 W/(m·K) or more, and obtained by curing the heat-dissipating coating composition according to any one of the first to fourth aspects.

If the member is thus configured, the heat-dissipating member that decreases temperature by efficiently converting heat energy from the thermal conductive component into far infrared rays, and radiating the far infrared rays to outside, and the heat-dissipating member that is excellent in the heat resistance and the UV resistance can be obtained.

A heat-dissipating member according to a sixth aspect of the invention has a cured film obtained by curing the heat-dissipating coating composition according to anyone of the first to fourth aspects of the invention; and a thermal conductive component having a thermal conductivity of 8 W/(m·K) or more, and the thermal conductive component coated with the cured film.

If the member is thus configured, the thermal conductive component (such as metal plate) having the high thermal conductivity plays a role of absorbing generated heat, and the heat absorbed spreads wholly inside the thermal conductive component to be transmitted to the cured film. A film formed of a resin single body is inferior, in the thermal conductivity, to the thermal conductive component, but the cured film formed of the heat-dissipating coating composition of the invention of the present application contains the filler of the orthorhombic silicate mineral, and therefore the heat-dissipating properties of the cured film are improved. Thus, the heat absorbed by the thermal conductive component and transmitted from the thermal conductive component to the cured film is efficiently radiated by the filler of the orthorhombic silicate mineral contained in the cured film, and the heat-dissipating member of the present application has an excellent heat-dissipating effect.

Moreover, the heat-dissipating member has the thermal conductive component, and therefore can further efficiently dissipate heat as a whole in comparison with a case where only the heat-dissipating coating composition is applied thereto and cured. Thus, the heat-dissipating member of the present application has a higher heat-dissipating effect by a combination of the cured film formed of the heat-dissipating coating composition, and the thermal conductive component.

In a heat-dissipating member according to a seventh aspect of the invention, the heat-dissipating member according to the sixth aspect of the invention, wherein the thermal conductive component is a component formed of at least one material selected from copper, aluminum, magnesium, iron, stainless steel or a composite material of the metal and graphite.

If the member is thus configured, the heat-dissipating member of the present application can be formed by using a metal plate particularly excellent in the thermal conductivity, or the like. Further, as is different from aluminum, copper that has so far unable to be subjected to anodic oxide coating processing can be used as a heat sink or a heat spreader in which the heat-dissipating effect is enhanced.

In a heat-dissipating member according to an eighth aspect of the invention, the heat-dissipating member according to the seventh aspect of the invention, wherein the composite material contains a polyvinyl acetal resin as a binder.

If the member is thus configured, the heat-dissipating member can be formed by using the composite material having a thin adhesion layer and high adhesive strength between a metal layer and a graphite layer.

In a heat-dissipating member according to a ninth aspect of the invention, the heat-dissipating member according to any one of the fifth to eighth aspects of the invention, wherein the cured film has a heat resistance of 200° C. or higher.

If the member is thus configured, the heat-dissipating member can be formed by using the cured film particularly excellent in the heat resistance. In particular, the heat-dissipating member can be used for a semiconductor for power control of an electric vehicle, and therefore such a case is preferred.

An article according to a tenth aspect of the invention has the heat-dissipating member according to any one of the fifth to eighth aspects of the invention; and a molded product coated with the heat-dissipating member.

If the article is thus configured, the heat-dissipating member has high heat-dissipating properties as well as the heat resistance and the UV resistance, and therefore heat of the molded product can be efficiently dissipated, and simultaneously even when the molded product is used outdoors, the article can withstand long-term use.

### Advantageous Effects of Invention

A heat-dissipating coating composition of the invention contains a filler of an orthorhombic silicate mineral, and a resin, and therefore has capability of forming a cured film having a high heat-dissipating effect. Further, in the cured film, the resin having the fillers carried therein may serve as a silicone-modified acrylic resin. Accordingly, the cured film formed of the heat-dissipating coating composition of the present application can have a high heat-dissipating effect as well as excellent heat resistance and UV resistance.

### BRIEF DESCRIPTION OF DRAWINGS

FIG. 1 is a drawing showing a configuration of heat-dissipating member 1.

FIG. 2 is a diagram showing a configuration of heat-dissipating member 10.

FIG. 3 is a flow diagram showing a method for producing heat-dissipating member 10.

### DESCRIPTION OF EMBODIMENTS

The present application is based on Japanese Patent Application No. 2015-173357 filed on Sep. 2, 2015 in Japan, and is hereby incorporated by reference in its entirety in the present application. The invention may be further completely understood by the detailed description described below. A further application scope of the invention will become apparent by the detailed description described below. However, the detailed description and a specific embodiment are desirable embodiments of the invention, and described only for illustrative purposes because various possible changes and modifications will be apparent to those having ordinary skill in the art on the basis of the detailed description within spirit and the scope of the invention. The applicant has no intention to dedicate to the public any described embodiment, and among the modifications and alternatives, those which may not literally fall within the scope of the present claims constitute a part of the invention in the sense of the doctrine of equivalents.

Hereinafter, an embodiment of the invention will be described with reference to drawings. In addition, in each Figure, an identical or similar sign is placed on apart identical or corresponding to each other, and overlapped description is omitted. Moreover, the invention is not limited by the embodiments described below.

### Heat-Dissipating Coating Composition

A heat-dissipating coating composition according to a first embodiment of the invention will be described. The heat-dissipating coating composition contains a filler of an orthorhombic silicate mineral, an acrylic resin and a curing agent, for example. Either the acrylic resin or the curing agent is silicone-modified, and the composition is cured to form a silicone-modified acrylic resin.

In addition, to the heat-dissipating coating composition, a filler excellent in thermal conductivity may be added as an additional filler, in addition to the filler of the orthorhombic silicate mineral.

Filler of Orthorhombic Silicate Mineral

Specific examples of the filler of the orthorhombic silicate mineral include mullite, cordierite, enstatite, hemimorphite, zoisite, sillimanite and andalusite. In particular, in view of high heat-radiating properties and suitability for mixing with the resin, cordierite or mullite is preferred. In addition, the orthorhombic silicate mineral may be any of a natural mineral and an artificial mineral. The heat-dissipating coating composition contains at least one kind of the fillers. The fillers are particularly excellent in an effect of radiating far infrared rays to improve heat-radiating properties of a cured film (coating film) formed of the heat-dissipating coating composition to enhance a heat-dissipating effect.

As a texture of the filler of the orthorhombic silicate mineral, powder, a paste form or the like is preferred. In particular, the filler is preferably mixed with the resin in the form of powder because a uniform state can be obtained. In the case of powder, a mean particle size thereof is 0.01 to 100 micrometers, preferably 0.1 to 50 micrometers, and particularly preferably 0.45 to 2.5 micrometers. If the mean particle size is 0.01 micrometer or more, viscosity of the heat-dissipating coating composition is not excessively increased, and workability in an application step is satisfactory. Moreover, the heat-dissipating properties are not deteriorated. If the mean particle size is 100 micrometers or less, projections and recesses are not formed on a surface of the cured film, and storage stability of the heat-dissipating coating composition is not deteriorated as caused by quick precipitation of the filler. In particular, if the filler of the orthorhombic silicate mineral having a mean particle size of 0.45 to 2.5 micrometers occupies 80% to 100% of the total weight of the filler, the cured film having translucency to a level close to transparency can be formed by using the heat-dissipating coating composition, and haze can be adjusted to 30% or less. In addition, a rest of weight, being 0 to 20%, may be the filler of the orthorhombic silicate mineral or the additional filler. In addition, the “mean particle size” means a particle size at an integrated value of 50% in a particle size distribution determined by a laser diffraction/scattering method.

As the particle size of the filler is smaller, aggregation is further easily caused, and therefore the cured film is prepared by preventing aggregation. As operation for preventing the aggregation, a method such as ultrasonic irradiation, use of a planetary centrifugal mixer, ball milling and beads milling can be applied thereto.

Additional Filler

The heat-dissipating coating composition may further contain the additional filler. Specific examples of the additional filler include at least one kind selected from the group of boron nitride, aluminum nitride, silica, alumina, zinc oxide, graphite and nanodiamond, each having a primary particle size of 100 micrometers or less. The above fillers have high thermal conductivity, and particularly, boron nitride or zinc oxide has high thermal conductivity, and can cause further improvement in the heat-dissipating effect of the cured film formed of the heat-dissipating coating composition, and therefore such a case is preferred.

As a texture of the additional filler, a powder form or a dispersion or the like is preferred. In particular, the additional filler is preferably mixed with the resin as powder because the uniform state can be obtained. In the case of powder, a mean particle size thereof is 0.01 to 100 micrometers, preferably 0.1 to 50 micrometers, and particularly preferably 0.45 to 2.5 micrometers. If the mean particle size is 0.01 micrometer or more, the viscosity of the heat-dissipating coating composition is not excessively increased, and workability in the application step is satisfactory. Moreover, the heat-dissipating properties are not deteriorated. If the mean particle size is 100 micrometers or less, the projections and recesses are not formed on the surface of the cured film, and the storage stability of the heat-dissipating coating composition is not deteriorated as caused by quick precipitation of the filler.

As the total amount of the filler of the orthorhombic silicate mineral and the additional filler, 1 to 80% by weight is preferably mixed therewith based on the total amount of the filler and the total amount of the binder resin. Thus, the satisfactory heat-dissipating effect can be obtained. When working efficiency of a step of applying the binder resin is taken into consideration, as the total amount of the filler of the orthorhombic silicate mineral and the additional filler, 15 to 60% by weight is preferred based on the total amount of the filler and the total amount of the binder resin. If the total amount of the filler and the additional filler is 15% by weight or more, heat-dissipating characteristics of the filler and the additional filler can be sufficiently obtained. Moreover, if the total amount of the filler and the additional filler is 60% by weight or less, a problem of aggregation in the binder resin, or the like is not caused. Further, hardness sufficient for the cured film can be obtained. In addition, as an amount of the additional filler, 0 to 20% by weight is mixed therewith based on the filler.

Solvent

A solvent may be used for mixing the filler with the binder resin. More specifically, as a method for preparing the heat-dissipating coating composition according to the embodiment of the invention, the binder resin may be mixed with the filler in the solution.

Specific examples of the solvent include methyl ethyl ketone, methyl isobutyl ketone, ethyl acetate, propyl acetate, butyl acetate, cyclohexanone, ethylbenzene, xylene, methyl methacrylate, 1-butanol or a mixture thereof.

As a mixing method, the solvent should be mixed using an ordinary agitator or dispenser such as an agitation motor, a mortar machine, a three-roll, a ball mill, a planetary centrifugal mill, a planetary mill and a beads mill may be used. Shear strength of agitation may be selected according to an apparatus to be used, and preferably adjusted to 10 to 1,000 Pa. If the shear strength is excessively strong, the particle size of the filler is excessively reduced, and if the shear strength is excessively weak, secondary particles are not subdivided, and the haze increases. If the particle size of the filler is large, heat radiation is satisfactory, and if the particle size of the filler is small, transparency is satisfactory.

Acrylic Resin

The acrylic resin (binder resin) is preferably a thermosetting resin. Specific examples thereof include a (meth)acrylic compound. The (meth)acrylic compound may be an acrylic monomer, an acrylic oligomer or an acrylic polymer having a crosslinkable functional group.

Specific examples of the (meth)acrylic compound include methyl (meth)acrylate, ethyl (meth)acrylate, n-propyl (meth)acrylate, n-butyl (meth)acrylate, t-butyl (meth)acrylate, isobutyl (meth)acrylate, ethylhexyl (meth)acrylate, isodecyl (meth)acrylate, n-hexyl (meth)acrylate, stearyl (meth)acrylate, lauryl (meth)acrylate, tridecyl (meth)acrylate, ethoxyethyl (meth)acrylate, methoxyethyl (meth)acrylate, glycidyl (meth)acrylate, butoxyethyl (meth)acrylate, 2-hydroxyethyl (meth)acrylate, 2-hydroxypropyl (meth)acrylate, 2-methoxyethyl (meth)acrylate, 2-ethoxy-ethoxyethyl (meth)acrylate, methoxydiethyleneglycol (meth)acrylate, ethoxydiethyleneglycol (meth)acrylate, methoxydipropyleneglycol (meth)acrylate, octafluoropentyl (meth)acrylate, N,N-dimethylaminoethyl (meth)acrylate, N,N-diethylaminoethyl (meth)acrylate, allyl (meth)acrylate, 1,3-butanediol (meth)acrylate, 1,4-butanediol (meth)acrylate, (meth)acryloyl morpholine, 1,6-hexandiol (meth)acrylate, polyethyleneglycol di(meth)acrylate, diethyleneglycol di(meth)acrylate, neopentylglycol di(meth)acrylate, triethyleneglycol di(meth)acrylate, tripropyleneglycol di(meth)acrylate, neopentylglycol di(meth)acrylate, trimethylolpropane di(meth)acrylate, 1,3-bis(hydroxyethyl)-5,5-dimethylhydantoin, 3-methylpentanediol (meth)acrylate, α,ω-diacrylbisdiethyleneglycol phthalate, trimethylolpropane tri(meth)acrylate, pentaerythritol (meth)acrylate, pentaerythritol hexa(meth)acrylate, dipentaerythritol monohydroxy penta(meth)acrylate, pentaerythritol tri(meth)acrylate, pentaerythritol tetra(meth)acrylate, tri(meth)acrylate of trihydroxyethyl isocyanurate (trade name: M-315, made by TOAGOSEI CO., LTD.), dipentaerythritol hexa(meth)acrylate, and an ethylene oxide or propylene oxide adduct of the (meth)acrylate having the hydroxyl group described above. The above (meth)acrylic compounds may be used alone, or a plurality of (meth)acrylic compounds may be combined and used.

Among the (meth)acrylic compounds, specific examples of polyester (meth)acrylate include polyester (meth)acrylate obtained by allowing (meth)acrylic acid to react with polyester prepared from polybasic acid or anhydride thereof and polyhydric alcohol. Specific examples of the polybasic acid include phthalic acid, succinic acid, adipic acid, glutaric acid, sebacic acid, isosebacic acid, tetrahydrophtalic acid, hexahydrophthalic acid, dimer acid, trimellitic acid, pyromellitic acid, pimelic acid and azelaic acid. Specific examples of the polyhydric alcohol include 1,6-hexandiol, diethylene glycol, 1,2-propylene glycol, 1,3-butylene glycol, neopentyl glycol, dipropylene glycol, polyethylene glycol and polypropylene glycol. The above polyester (meth)acrylates may be used alone, or a plurality of polyester (meth)acrylates may be combined and used.

Among the (meth)acrylic compounds, specific examples of epoxy (meth)acrylate include a (meth)acrylic acid-modified epoxy compound obtained by adding (meth)acrylic acid to an epoxy compound. The above epoxy compound provided for modification is obtained by allowing epichlorohydrin to react with bisphenol A, bisphenol F, bisphenol S or phenol novolak, cyclopentadiene oxide or cyclohexane oxide. The above epoxy (meth)acrylates may be used alone, or a plurality of epoxy (meth)acrylates may be combined and used.

Among the (meth)acrylic compounds, specific examples of polyether (meth)acrylate include polyether (meth)acrylate obtained by a transesterification reaction between polyether and (meth)acrylic acid ester such as ethyl (meth)acrylate. Specific examples of the polyether include polyether obtained by ethoxylation and propoxylation of trimethylolpropane, pentaerythritol or the like, and polyetherification of 1,4-butanediol or the like. The above polyether (meth)acrylates may be used alone, or a plurality of polyether (meth)acrylates may be combined and used.

Among the (meth)acrylic compounds, specific examples of polyurethane (meth)acrylate include polyurethane (meth)acrylate obtained by allowing a hydroxy group-containing (meth)acrylate compound to react with an isocyanate compound, a polyol compound. Specific examples of the isocyanate compound include tolylene diisocyanate, xylylene diisocyanate, hexamethylene diisocyanate and isophorone diisocyanate. Specific examples of the polyol compound include an adduct of bisphenol A and ethyleneoxide, bisphenol A, neopentyl glycol, 1,6-hexandiol and trimethylolpropane. Specific examples of the hydroxy group-containing (meth)acrylate compound include hydroxyl group-containing alkyl ester of (meth)acrylic acid, such as 2-hydroxyethyl (meth)acrylate, 2-hydroxypropyl (meth)acrylate and 2-hydroxybutyl (meth)acrylate. The above polyurethane (meth)acrylates may be used alone, or a plurality of polyurethane (meth)acrylates may be combined and used.

Among the above compounds, at least one kind selected from the group of polyfunctional (meth)acrylate, epoxy (meth)acrylate, urethane (meth)acrylate, polyester (meth)acrylate and polyether (meth)acrylate is preferred.

A thermally decomposable radical generator is used as a polymerization initiator of the thermosetting resin. For example, an azo initiator, a peroxide-based initiator and a dihalogen initiator are generally used. AIBN (2,2′-azobis(isobutyronitrile)), ABCN (azobiscyanocyclohexyl), benzoyl peroxide and tert-butyl hydroperoxide and so forth are particularly frequently used. A polymer azo initiator is also preferred in view of no remaining of low molecular weight impurities. A preferred amount of addition of the polymerization initiator is 0.05 to 3.0% by weight.

Curing Agent

The heat-dissipating coating composition preferably contains a curing agent as a crosslinkable ingredient. Specific examples of the crosslinkable ingredient include an isocyanate compound (such as isocyanate, aliphatic isocyanate, aromatic isocyanate and polyisocyanate), a diisocyanate compound and a phenolic compound. Specific examples thereof further include acid, base, a thermal acid generator, an acid anhydride-based curing agent or an amine-based curing agent.

As the thermal acid generator, alkyl or aryl sulfonate, in particular, isopropyl-p-toluenesulfonate or perfluoroalkyl sulfonate, and in particular, perfluorooctane sulfonate is preferred. Specific examples of the acid anhydride-based curing agent include aromatic acid anhydride, cycloaliphatic trianhydride and aliphatic acid anhydride. Specific examples of the acid anhydride-based curing agent include phthalic anhydride, methyltetrahydrophthalic anhydride, tetrahydrophthalic anhydride, anhydrous methylnadic acid, hexahydrophthalic anhydride and methylhexahydrophthalic anhydride. Specific examples of the amine-based curing agent include imidazoles, secondary and tertiary amines. Specific examples of the imidazoles include imidazole, 2-methylimidazole, 2-ethylimidazole, 1-cyanoethyl-2-undecylimidazolium-trimellitate and epoxy-imidazole adduct. Specific examples of the secondary and tertiary amines include piperidine, N,N-dimethylpiperazine, triethylenediamine, benzyldimethylamine, 2-(dimethylaminomethyl)phenol and 2,4,6-(dimethylaminomethyl)phenol. An amount of addition is preferably in the range of 0.01 to 20 parts by weight, and particularly preferably in the range of 0.5 to 10 parts by weight, based on 100 parts by weight of the curable compound (thermosetting resin).

Further, either the (meth)acrylic compound or the curing agent is silicone-modified. The compound or the agent only needs be silicone-modified at a degree at which the acrylic resin after curing produces advantageous effects of the invention of the present application. More specifically, the compound or the agent only needs be silicone-modified at a degree at which the heat resistance and the UV resistance are improved in comparison with the acrylic resin that is not silicone-modified.

For example, the heat resistance is at a degree at which yellowing is unable to be visually confirmed after the cured film having a thickness of 30 micrometers is left to stand under an environment at 100° C. for 10 minutes. The cured film preferably has such heat resistance of 100° C. or higher. The cured film further preferably has a heat resistance of 150° C. or higher, and further preferably has a heat resistance of 200° C. or higher.

The UV resistance is at a degree at which deterioration (such as yellowing and flaking) is unable to be visually confirmed on the cured film having a thickness of 30 micrometers even after elapse of 24 hours under conditions of light source: UVB-313, irradiance: 0.71 W/m²/nm, black panel temperature during UV irradiation: 60° C., temperature during dew formation: 50° C. The cured film preferably has such UV resistance of 24 hours or more in an outdoor exposure accelerated test. The cured film further preferably has a UV resistance of 48 hours or more, and further preferably has a UV resistance of 72 hours or more.

Additive

The heat-dissipating coating composition further contains a dispersant, a color pigment and a silane coupling agent, as an additive.

As the dispersant, such a material is used as hydroxyl group-containing carboxylic acid ester, a salt of long chain polyaminoamide and high molecular weight acid ester, a salt of high molecular weight polycarboxylic acid, a salt of long chain polyaminoamide and polar acid ester, high molecular weight unsaturated acid ester, a high molecular weight copolymer, modified polyurethane, modified polyacrylate, a polyether ester type anionic surface active agent, naphthalenesulfonic acid formalin condensate salt, an aromatic sulfonic acid-formalin condensate salt, polyoxyethylene alkyl phosphoric acid ester, polyoxyethylene nonylphenyl ether and stearylamine acetate (addition of 1 to 15% by weight based on the filler). Aggregation of the filler can be prevented to improve the storage stability of the heat-dissipating coating composition.

As the color pigment, an organic pigment and an inorganic pigment can be used. An inorganic pigment is preferred.

As the silane coupling agent, a silane coupling agent made by JNC Corporation (trade names: S330, 5510, S520, S530) is preferred. Adhesion between the metal plate and the cured film can be improved by adding 1 to 10% by weight based on the heat-dissipating coating composition.

### Heat-Dissipating Member

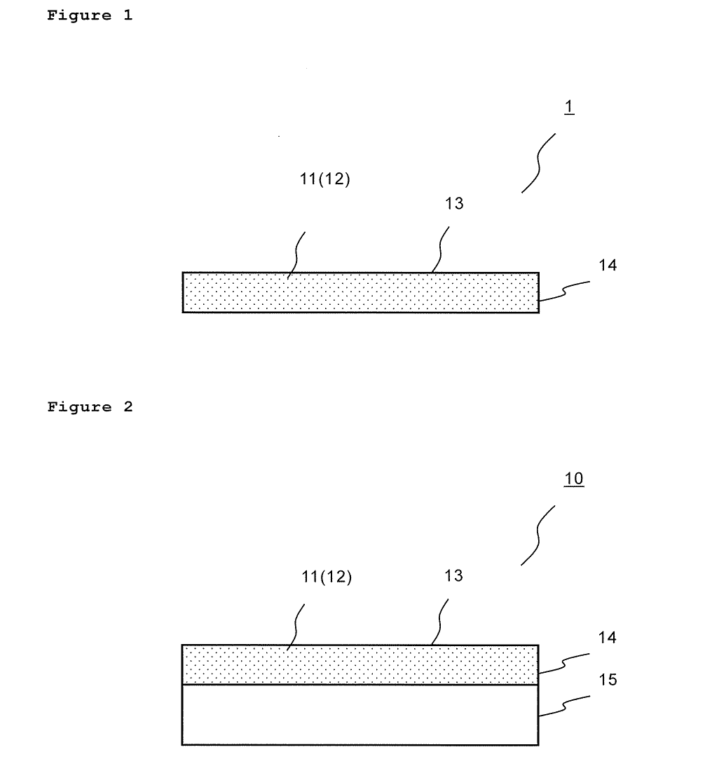

With reference to FIG. 1, heat-dissipating member 1 according to a second embodiment of the invention will be described. In addition, FIG. 1 is provided for describing a configuration of heat-dissipating member 1, and a thickness of the layer is shown in an exaggerated manner. Heat-dissipating member 1 is cured film 14 formed of a heat-dissipating coating composition containing filler 11 of an orthorhombic silicate mineral and binder resin 13. In addition, additional filler 12 excellent in thermal conductivity may be added to the heat-dissipating coating composition in addition to filler 11 of the orthorhombic silicate mineral. Moreover, if a filler without adversely affecting transparency of the cured film is used as the additional filler, for example, if graphite is used in the range of haze of 30% or less, the cured film can be colored to transparent black, and therefore design performance of the heat-dissipating member itself can be improved.

When cured film 14 is used as the heat-dissipating member, the heat-dissipating member is preferably arranged on a part of a molded product from which heat is desired to be radiated, and a portion having high thermal conductivity (thermal conductive component). For example, the heat-dissipating member is preferably arranged on the thermal conductive component having a thermal conductivity of 8 W/(m·K) or more. Specific examples of the thermal conductive component include a component formed of at least one material selected from copper, aluminum, magnesium, iron, stainless steel, or a composite material of the above metal and graphite.

With reference to FIG. 2, heat-dissipating member 10 according to a third embodiment of the invention will be described. In addition, FIG. 2 is provided for describing a configuration of heat-dissipating member 10, and a thickness of each layer is shown in an exaggerated manner. Heat-dissipating member 10 is produced by applying the heat-dissipating coating composition containing filler 11 of the orthorhombic silicate mineral and binder resin 13 on metal plate 15, and then forming cured film 14 thereon. In addition, additional filler 12 excellent in the thermal conductivity may be further added to the heat-dissipating coating composition in addition to filler 11 of the orthorhombic silicate mineral.

Thus, heat-dissipating member 10 is configured by combining the thermal conductive component having the high thermal conductivity such as metal plate 15 with cured film 14. Specific examples of the thermal conductive component include a material having a thermal conductivity of at least 8 W/(m·K), and a component formed of at least one material selected from copper, aluminum, magnesium, iron, stainless steel, or a composite material of the above metal and graphite.

The composite material of the metal and graphite is preferably formed of a binder containing a polyvinyl acetal resin. As a method for producing the composite material of the metal and the graphite by using the binder containing the polyvinyl acetal resin, the methods disclosed in JP 2012-136022 A and JP 2013-157590 A can be applied.

A thickness of the metal plate or the like of heat-dissipating member 10 is appropriately selected according to a place on which heat-dissipating member 10 is placed. When a heat source is small and an area of the heat-dissipating member is sufficiently large, as the thickness is larger, the heat-dissipating effect is higher. For example, when heat-dissipating member 10 is used for an electronic component, the thickness of the metal plate or the like is 0.03 to 100 millimeters, preferably 0.1 to 10 millimeters, and further preferably 0.2 to 2 millimeters. Such a thickness is preferred in that, if the thickness is 0.03 millimeter or more, heat-dissipating member 10 is excellent in the heat-dissipating effect, and if the thickness is 100 millimeters or less, heat-dissipating member 10 is lightweight.

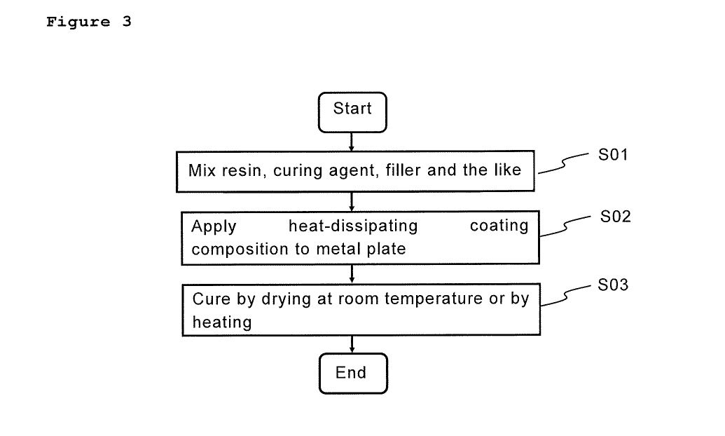

With reference to FIG. 3, a method for producing heat-dissipating member 1 will be described by taking a case where a thermosetting resin is used as a binder resin, as an example.

S01: A thermosetting resin, a curing agent, powder of a filler of an orthorhombic silicate mineral, and a polymerization initiator dissolved in a solvent are mixed using an agitation motor, a mortar machine, a three-roll, a ball mill, a planetary centrifugal mill, a planetary mill, a beads mill or the like. On the occasion, when necessary, at least one kind of an additional filler, a dispersant, a color pigment and a silane coupling agent may be added thereto and mixed.

As the solvent, a ketone or ester-based solvent is preferred, and specific examples thereof include acetone, methyl ethyl ketone, methyl isobutyl ketone, DIBK (diisobutyl ketone), cyclohexanone, DAA (diacetone alcohol), or ethyl acetate, methyl acetate, butyl acetate, methoxybutyl acetate, cellosolve acetate, amyl acetate, n-propyl acetate, isopropyl acetate, methyl lactate, ethyl lactate and butyl lactate.

A concentration of a thermosetting resin ingredient in the heat-dissipating coating composition can be appropriately selected by being adjusted to viscosity according to a laminating method. For example, for a wet coating method, 5 to 90% by weight is preferred and the range of 30 to 80% by weight is further preferred.

S02: The heat-dissipating coating composition prepared in S01 is applied to a metal plate, for example.

In addition, a cured film is preferably formed to be 0.1 to 1,000 micrometers in a film thickness after curing. The film thickness is preferably 10 to 100 micrometers. The film thickness is further preferably 20 to 40 micrometers. When the film thickness is increased, emissivity is increased, and therefore a heat-dissipating effect by radiation is increased. When the film thickness is decreased, thermal conductivity is increased. Accordingly, a suitable film thickness is selected according to an application.

As an application method, the wet coating method according to which the heat-dissipating coating composition is uniformly coated thereon is preferably used. Among the wet coating methods, when a small amount is prepared, a spin coating method according to which uniform film can be formed in a simple manner is preferred. When productivity is considered to be important, a gravure coating method, a die coating method, a bar coating method, a reverse coating method, a roll coating method, a slit coating method, a dipping method, a spray coating method, a kiss coating method, a reverse kiss coating method, an air knife coating method, a curtain coating method, a rod coating method or the like is preferred. The wet coating method can be appropriately selected from the above methods according to a film thickness, viscosity, curing conditions or the like to be required.

S03: The resulting material is dried at room temperature or by heating to cure the heat-dissipating coating composition to form a film.

As described above, heat-dissipating member 1 being the cured film (coating film) formed of the heat-dissipating coating composition of the invention, or heat-dissipating member 10 having the cured film (coating film) can be used in a molded product for a heat-generating electronic component itself, a self-heating device or machine, such as a lighting device and a machine tool to provide the high heat-dissipating effect.

Further, the cured film formed of the heat-dissipating coating composition of the invention has the UV resistance and the heat resistance in addition to the heat-dissipating properties. Accordingly, the cured film is suitable for heat radiation of the molded product, for example, heat radiation of a device generating heat in itself, such as an outdoor light, a traffic signal, a switchboard, a switchgear assembly, which are installed outdoors, and a motor of a motorbike and an electric vehicle, heat radiation of a member that is not a heating unit but easy to have heat (for example, a brake pad and a frame of a solar battery), and further heat radiation of a material that is readily affected by heat (for example, an aluminum sash).

The cured film of the invention may be directly applied to a portion having the high thermal conductivity such as metal of the articles described above, or may be used by being combined with a member having the high thermal conductivity such as metal. The cured film has a higher heat-dissipating effect by a combination with the metal or the like. Further, the cured film and the molded product can be produced in division of labor, and the cured film can be easily placed on the molded product, and therefore production is easy, and production efficiency can be improved.

### EXAMPLES

Hereinafter, the invention will be described in detail by way of Examples. However, the invention is not limited to the content described in Examples described below. In addition, room temperature means 26° C.

Ingredient materials constituting a heat-dissipating member, which were used in Examples of the invention, are as described below.

A curable resin such as an acrylic resin is also referred to as a base resin in several cases.

### Base Agent of a Heat-Dissipating Coating Composition

### Example 1: Silicone Acrylic Resin Coating

ALC1: Base resin=(trade name) Alco SP No. 100 Clear XS-100, Natoco Co., Ltd., and curing agent=Alco SP No. 1 curing agent XS-001, Natoco Co., Ltd.

### Example 2: Silicone Acrylic Resin Coating

TRS1: Base resin=(trade name) TR Sealer, AGC COAT-TECH Co., Ltd., and curing agent=TR Sealer curing agent, AGC COAT-TECH Co., Ltd.

### Example 3: Silicone Modified Acrylic Coating

DYP1: Base resin=(trade name) DYPC S-110, TOYO INK CO., LTD., and curing agent=SUR 200 (aliphatic isocyanate), TOYO INK CO., LTD.

### Example 4: Silicone Modified Acrylic Coating

DYP2: Base resin=(trade name) DYPC S-110, TOYO INK CO., LTD., and curing agent=UR-300B (aromatic isocyanate), TOYO INK CO., LTD.

In addition, a thinner specified by each company was used for dilution for viscosity adjustment of each coating agent, and cleaning of instruments.

### Filler of Orthorhombic Silicate Mineral

Synthetic cordierite: (trade name) SS-1000 (mean particle size: 1.7 μm), MARUSU GLAZE Co., Ltd.

### Coating for Comparison

### Comparative Example 1

Aqueous urethane heat-dissipating coating (only drying), (trade name) TP-3001WD, JNC Corporation

### Comparative Example 2

Acrylic heat-dissipating coating (thermoset, not silicone-modified), (trade name) PELCOOL H-7001 (white), Pelnox Limited

### Comparative Example 3

Base resin=(trade name) TR Sealer, AGC Coat-Tech Co., Ltd., curing agent=TR Sealer, AGC Coat-Tech Co., Ltd., and curing agent=TR Sealer curing agent (without adding heat-dissipating filler), made by AGC Coat-Tech Co., Ltd.

### Comparative Example 4

No coating film

### Sample Preparation Method

A planetary centrifugal mixer (Thinky Mixer ARE-250, made by Thinky Corporation) was used, and each coating base agent and powder of filler were agitated at a rotational speed of 2,000 rpm for 10 minutes, and then the resulting mixture was defoamed at a rotational speed of 2,200 rpm for 10 minutes to prepare a sample of a heat-dissipating coating (heat-dissipating coating composition).

### Examples 1 to 4

To 36 g of ALC1 (material obtained by previously mixing a base resin and a curing agent at a ratio of 30 g:6 g (parts by weight)), 4.62 g of the filler was added to be 30% by weight in a proportion of the filler to a resin ingredient, and the resulting mixture was put in a polypropylene container, and mixed by a planetary centrifugal mixer, and the resulting material was taken as a sample in Example 1. The sample was applied to an aluminum plate having all sides of 40×40 (mm) and a thickness of 0.4 mm by using a spin coater (made by Mikasa Co., Ltd.: MS-A150 model). A rotational speed of the spin coater was adjusted in such a manner that a cured film (coating film) in each of Example and Comparative Example had about 30 μm. A film thickness was measured by using DIGIMICRO MFC-101A made by Nikon Corporation.

As shown in Table 3, each sample applied in Examples and Comparative Examples was dried to form a heat-dissipating member having the aluminum plate.

Also for Examples 2 to 4, a sample was prepared to be 30% by weight in a proportion of a filler based on a resin ingredient in a manner similar to Example 1.

Ingredients in Examples 1 to 4 and conditions of forming the cured films (coating films) are summarized in Tables 1 to 3.

TABLE 1
Table 1 Composition of base agent in Examples 1 to 4

| | Base resin | Curing agent |
|---|---|---|
| Example 1 | (Alco SP No100 | (Alco SP No1 |
| | Clear XS-100) | curing agent XS-001) |
| | Silicone-modified acrylic resin | |
| Example 2 | Acrylic polyol resin | Silicone-modified |
| | | polyisocyanate |
| Example 3 | Silicone-modified acrylic resin | Aliphatic isocyanate |
| Example 4 | Silicone-modified acrylic resin | Aromatic isocyanate |

TABLE 2
Table 2 Table of ingredients in Examples 1 to 4

| | | | | Proportion of filler |
|---|---|---|---|---|
| | | | | based on resin |
| | Base resin | Curing agent | Filler | ingredients |
| | (g) | (g) | (g) | (% by weight) |
| Example 1 | 30.0 | 6.00 | 4.62 | 30 |
| Example 2 | 30.0 | 3.69 | 5.58 | 30 |
| Example 3 | 30.0 | 4.50 | 5.04 | 30 |
| Example 4 | 30.0 | 6.00 | 5.52 | 30 |

TABLE 3
Table 3 Resin portion curing conditions in Examples
1 to 4 and Comparative Examples 1 to 4

| | Preliminary | Preliminary | | | Curing | |
|---|---|---|---|---|---|---|
| | drying | drying | | Curing | drying | |
| | temperature | time | | temperature | time | |
| Example 1 | Room | 24 | hours | Room | 3 | days |
| | temperature | | | temperature | | |
| Example 2 | Room | 6 | hours | Room | 1 | day |
| | temperature | | | temperature | | |
| Example 3 | 80° C. | 1 | hour | Room | 1 | week |
| | | | | temperature | | |
| Example 4 | 80° C. | 1 | hour | Room | 1 | week |
| | | | | temperature | | |
| Comparative | 80° C. | 1 | hour | No need | No need | |
| Example 1 | | | | | | |
| Comparative | 80° C. | 10 | minutes | 160° C. | 20 | minutes |
| Example 2 | | | | | | |
| Comparative | Room | 6 | hours | Room | 1 | day |
| Example 3 | temperature | | | temperature | | |

| | | | | |
|---|---|---|---|---|
| Comparative | No coating | No coating | No coating | No coating |
| Example 4 | film | film | film | film |

### Evaluation Method for Heat-Radiation Characteristics

On a side of an aluminum surface of the heat-dissipating member in which the cured film (coating film) was formed on the aluminum plate, which was prepared in Example 1, a transistor (TOSHIBA Transistor Silicon NPN Triple Diffused Type 2SD2012) was adhered by using a double-sided tape (Thermal Conductive Adhesive Transfer Tape No. 9885, made by Sumitomo 3M Co., Ltd.). A K thermocouple (ST-50, made by RKC Instrument Inc.) was attached to a rear surface of a surface of the transistor, on which the heat-dissipating member was adhered, and a temperature was recorded using a data logger by means of a personal computer. The heat-dissipating member to which the transistor was attached was left to stand in a center of a constant-temperature bath set to 40° C., and a temperature of the transistor was confirmed to be constant at 40° C., and then 1.20 V was applied to the transistor by using a regulated DC power supply, and a change in the temperature on the surface of the transistor was measured. In the above method, a heating value of the transistor is constant, and therefore as a heat-dissipating quantity from the cured film (coating film) is larger, the temperature of the transistor is kept to a lower level. In addition, heat-dissipating members each having the aluminum plate (samples 1 to 3) were prepared by three for each Example, and each sample was evaluated.

TABLE 4
Table 4 Transistor temperature after 30 minutes from current flow

| | Transistor temperature after 30 minutes (° C.) | | | |
|---|---|---|---|---|
| | | | | Mean |
| | Sample 1 | Sample 2 | Sample 3 | value |
| Example 1 | 69.2 | 68.9 | 68.7 | 68.9 |
| Example 2 | 69.4 | 69.8 | 68.4 | 69.2 |
| Example 3 | 70.0 | 69.4 | 68.6 | 69.1 |
| Example 4 | 69.5 | 69.9 | 68.9 | 69.4 |
| Comparative Example 1 | 70.4 | 69.6 | 68.5 | 69.5 |
| Comparative Example 2 | 70.7 | 70.1 | 69.8 | 70.2 |
| Comparative Example 3 | 73.2 | 72.6 | 72.7 | 72.8 |
| Comparative Example 4 | 77.1 | 76.7 | 78.2 | 77.3 |

### Evaluation Results of Heat Radiation Characteristics

In comparison between Examples 1 to 4 and Comparative Example 1, for example, even when Comparative Example 1 in which the temperature is the highest (69.5° C.) is compared with Example 1 in which the temperature is the lowest (68.9° C.), a difference in the temperature between the transistors after 30 minutes is only 0.6° C. The characteristics were evaluated three times because the difference was small, but no significant difference was found even by such an evaluation. The difference in temperature is within variations of the thickness of the cured film (coating film) and variations of heat resistance during adhering the transistor to the sample, and therefore no difference reasonably exists. More specifically, the coatings in Examples 1 to 4 have heat-dissipating properties comparable to (or slightly superior to) properties of the aqueous urethane heat-dissipating coating in Comparative Example 1.

Moreover, in Examples 1 to 4, the temperature of the transistor is somewhat decreased in comparison with the acrylic heat-dissipating coating not silicone-modified (Comparative Example 2).

Moreover, in Examples 1 to 4, the temperature of the transistor is decreased by about 3° C. in comparison with a case where the coating contains no filler (Comparative Example 3).

Further, in Examples 1 to 4, the temperature of the transistor is decreased by about 8° C. in comparison with a case where the coating has no cured film (coating film) (Comparative Example 4).

### Evaluation of Heat-Resistant Temperature

The heat-dissipating coating is used at a hot temperature in many cases, and therefore the samples in which the heat-dissipating coating films were formed in Examples 1 to 4 and Comparative Examples 1 to 3 were each arranged on a hot plate, and a temperature at which the cured film (coating film) was yellowed was examined by gradually increasing temperatures to 100° C., 120° C., 130° C., 150° C., 160° C., 180° C. and 200° C. In addition, a predetermined temperature was held for 10 minutes after the sample reached each temperature, and the sample after 10 minutes was visually confirmed. A temperature at which yellowing started was summarized in Table 5.

TABLE 5
Table 5 Comparison of yellowing temperature

| | Temperature at which yellowing started (° C.) |
|---|---|
| Example 1 | 120° C. |
| Example 2 | 200° C. or higher(no change |
| | at 200° C.) |
| Example 3 | 130° C. |
| Example 4 | 120° C. |
| Comparative Example 1 | 130° C. |
| Comparative Example 2 | 180° C. |
| Comparative Example 3 | 200° C. or higher(no change |
| | at 200° C.) |
| Comparative Example 4 | Aluminum was gradually oxidized |
| | from about 180° C. |

### Comparison of Heat-Resistant Temperature

All samples have a heat resistance of at least about 120° C.

In comparison between Examples 1 to 4 and Comparative Example 1, no difference in the heat resistant temperature is found between the ordinary aqueous urethane resin (Comparative Example 1) and the silicone-modified acrylic coating (Examples 1 to 4). In addition, in the coating in which silicone was incorporated into a portion on a side of the curing agent, which was used in Example 2 and Comparative Example 3, the heat-resistant temperature was specifically high, and no change was found in a color and on the surface of the cured film (coating film) even at 200° C. or higher. Moreover, in Comparative Example 2, the resin is not silicone-modified, but the resin is of a thermosetting type and is ordinarily cured at 160° C., and further in Comparative Example 2 only, a white pigment is incorporated thereinto, and yellowing of the resin is covered therewith, and therefore the heat resistance is visually observed to be high.

### Comparison Method for UV Resistance

For the heat-dissipating coating, an application used inside electronic equipment is considered (reference: Hinatsu et al., Journal of Japan Institute of Electronics Packaging, May, 2014, (Vol. 17, No. 3), pp. 175 to 179), but the heat-dissipating coating is also expected in the application used outdoors, such as an LED lighting device for outdoor use or on a shade side of a solar battery panel. Then, an accelerated test of outdoor exposure was conducted by using a model QUV type accelerated weathering tester made by Q-Lab Corporation. A test for 96 hours at a cycle of 4 hours for each was conducted on, as a sample, a material on which a heat-dissipating coating film was formed on the same aluminum plate with the place used in Examples 1 to 4 by using UVB-313 as a light source and adjusting irradiance to 0.71 W/m²/nm, a black panel temperature during UV irradiation to 60° C., and a temperature during dew formation to 50° C. The results are summarized in Table 6.

TABLE 6
Table 6 Comparison in outdoor exposure accelerated test

| | Sate of surface after 96 hours (visual observation) |
|---|---|
| Example 1 | Somewhat yellowing is found on the coating film, |
| | but deterioration or flaking other than yellowing |
| | is not found. |
| Example 2 | No change |
| Example 3 | Yellowing is heavy, and the surface is rough |
| Example 4 | The coating film is clouded, and has pimples on |
| | the surface. |
| Comparative | Somewhat yellowing is found on the coating film, |
| Example 1 | but deterioration or flaking other than yellowing |
| | is not found. |
| Comparative | The coating film is slightly yellowed, and |
| Example 2 | significantly deglossed. |
| Comparative | No change |
| Example 3 | |
| Comparative | Aluminum is oxidized to brown color |
| Example 4 | |

### Comparison of UV Resistance

In Examples 1 to 4, the silicone-modified acrylic resin is used, and therefore UV resistance of the heat-dissipating member is improved. Meanwhile, in comparison among Examples 1 to 4, a marked effect was obtained particularly in Example 2. The reason is considered as described below. In the outdoor exposure accelerated test, the coating film is not only irradiated with UV, but also in a high humidity state, and when a large amount of filler of oxide is mixed therein as in the heat-dissipating coating, water molecules are penetrated into an interface between the filler and the resin, and therefore a rate of deterioration of the resin is increased in comparison with a resin single body in many cases by progress of penetration of the water molecules and a catalytic reaction on a filler surface. However, even though the filler is incorporated into the base coating in Example 2, high UV resistance is maintained because the isocyanate compound used in the curing agent is silicone-modified, and water resistance is improved.

All the documents including a publication, a patent application and a patent quoted herein are herein referred to and incorporated at the same degree as showing, referring to and incorporating each document individually specifically, and describing all the contents herein.

Use of a noun and a similar reference term to be used with regard to description of the invention (with regard to particularly the following claims) is construed to be performed in both a singular number and a plural number unless the use is particularly pointed out herein or clearly contradicts a context. Unless otherwise noted, expressions “equip,” “have,” “include” and “contain” are construed as open-ended terms (more specifically, meaning of “include, but not limited to”). Unless particularly pointed out herein, specification of the range of a numerical value herein has intention of simply playing a role as an abridged notation for individually referring to each value applicable in the range thereof, and each value is incorporated herein as if the value is individually listed herein. All the methods described herein can be performed in every suitable order unless the methods are particularly pointed out herein or clearly contradicts a context. Unless particularly claimed, every example or expression in exemplification used herein (for example, “or the like”) has intention of simply better describing the invention, and is not limited to the scope of the invention. Any expression herein is not construed to be an expression that is absolutely necessary to practice of the invention and represents an element that is not described in claims.

Herein, preferred embodiments of the invention are described including a best embodiment that is known by the present inventors for practicing the invention. Deformation of the preferred embodiments will become clear for a person skilled in the art after the person reads description described above. The inventor expects that a skilled person appropriately applies such deformation, and the inventor expects that the invention is practiced by a method other than a method specifically described herein. Accordingly, as allowed in an applicable law, the invention includes all the modifications of and equivalents to contents according to claims attached hereto. Furthermore, any combination of elements described above in all deformation is contained by the invention unless the combination is particularly pointed out herein or clearly contradicts a context.

### REFERENCE SIGNS LIST

1 Heat-dissipating member
10 Heat-dissipating member having metal plate
11 Filler
12 Additional filler
13 Binder resin
14 Cured film
15 Metal plate

1. A heat-dissipating coating composition, containing:
a filler of an orthorhombic silicate mineral; and
an acrylic resin and a curing agent,
wherein either the acrylic resin or the curing agent is silicone-modified.

2. The heat-dissipating coating composition according to claim 1, wherein the acrylic resin is a curable resin composed of a silicone-modified (meth)acrylic compound, and the curing agent is a curing agent containing an isocyanate group, or the acrylic resin is a curable resin composed of a (meth)acrylic compound, and the curing agent is a silicone-modified curing agent containing an isocyanate group.

3. The heat-dissipating coating composition according to claim 1, wherein the orthorhombic silicate mineral is cordierite or mullite.

4. The heat-dissipating coating composition according to claim 1, further containing at least one kind of additional filler selected from the group of boron nitride, aluminum nitride, silica, alumina, zinc oxide, graphite and nanodiamond.

5. A heat-dissipating member, being a cured film, arranged in a thermal conductive component having a thermal conductivity of 8 W/(m·K) or more, and obtained by curing the heat-dissipating coating composition according to claim 1.

6. A heat-dissipating member, having a cured film obtained by curing the heat-dissipating coating composition according to claim 1; and a thermal conductive component having a thermal conductivity of 8 W/(m·K) or more, and the thermal conductive component coated with the cured film.

7. The heat-dissipating member according to claim 6, wherein the thermal conductive component is a component formed of at least one material selected from copper, aluminum, magnesium, iron, stainless steel or a composite material thereof and graphite.

8. The heat-dissipating member according to claim 7, wherein the composite material contains a polyvinyl acetal resin as a binder.

9. The heat-dissipating member according to claim 5, wherein the cured film has a heat resistance of 200° C. or higher.

10. An article, having:
the heat-dissipating member according to claim 5; and
a molded product coated with the heat-dissipating member.

11. A heat-dissipating member, being a cured film, arranged in a thermal conductive component having a thermal conductivity of 8 W/(m·K) or more, and obtained by curing the heat-dissipating coating composition according to claim 2.

12. A heat-dissipating member, being a cured film, arranged in a thermal conductive component having a thermal conductivity of 8 W/(m·K) or more, and obtained by curing the heat-dissipating coating composition according to claim 3.

13. A heat-dissipating member, being a cured film, arranged in a thermal conductive component having a thermal conductivity of 8 W/(m·K) or more, and obtained by curing the heat-dissipating coating composition according to claim 4.

14. A heat-dissipating member, having a cured film obtained by curing the heat-dissipating coating composition according to claim 2; and a thermal conductive component having a thermal conductivity of 8 W/(m·K) or more, and the thermal conductive component coated with the cured film.

15. A heat-dissipating member, having a cured film obtained by curing the heat-dissipating coating composition according to claim 3; and a thermal conductive component having a thermal conductivity of 8 W/(m·K) or more, and the thermal conductive component coated with the cured film.

16. A heat-dissipating member, having a cured film obtained by curing the heat-dissipating coating composition according to claim 4; and a thermal conductive component having a thermal conductivity of 8 W/(m·K) or more, and the thermal conductive component coated with the cured film.

17. An article, having:
the heat-dissipating member according to claim 6; and
a molded product coated with the heat-dissipating member.

18. An article, having:
the heat-dissipating member according to claim 7; and
a molded product coated with the heat-dissipating member.

19. An article, having:
the heat-dissipating member according to claim 8; and
a molded product coated with the heat-dissipating member.

20. An article, having:
the heat-dissipating member according to claim 9; and
a molded product coated with the heat-dissipating member.
